(19) United States
(12) Patent Application Publication
(10) Pub. No.: US 2011/0272904 A1
(43) Pub. Date: Nov. 10, 2011

(54) SKATEBOARD WHEEL AND METHOD OF MANEUVERING THEREWITH

(76) Inventors: Robert John Lewis, Crest Hill, IL (US); James Brian Yarbrough, Lisle, IL (US)

(21) Appl. No.: 13/101,864

(22) Filed: May 5, 2011

Related U.S. Application Data
(63) Continuation-in-part of application No. 12/775,077, filed on May 6, 2010.

(51) Int. Cl. B62M 1/00; B23P 19/04

(52) U.S. Cl. 280/87.042; 29/402.03

(57) ABSTRACT

The present disclosure generally relates to a spherical or curved skateboard wheel with a grind face that is interchangeable with ordinary, standardized skateboard wheels used in the marketplace. The wheel in some embodiments provides greater weight to the board and protects internal bearings by not resulting in preferential shock positions within each wheel. Further, the spherical wheels allow for higher speed, reduced friction with the road surface when desired, reduction of random bounces of the board during tricks, and increased maneuverability over dry, granular, or soft surfaces.

### RELATED APPLICATION

This application is a continuation-in-part of and claims the benefit of and priority from U.S. patent application Ser. No. 12/775,077, filed May 6, 2010, entitled SKATEBOARD WHEEL AND METHOD OF MANEUVERING THEREWITH, which application is expressly incorporated herein by reference.

### FIELD OF THE DISCLOSURE

The present disclosure generally relates to a spherical skateboard wheel and method of maneuvering a skateboard therewith, and more specifically, to a new geometry of skateboard wheel capable of mounting on existing skateboard frames with an internal bearing set for greatly improving a wide range of properties of the skateboard and different methods of maneuvering therewith.

### BACKGROUND

In the early 1970s, plywood boards combined with quad-wheeled hardware allowed children to move around and perform tricks and stunts while riding on the wooden board. By the mid-1980s, Skateboards were mass produced in the United States to the pleasure of many adolescents. A boarder propels himself by pushing off on the ground with one foot while the other remains on the board. When the board moves down a slope, a boarder can simply stand with both feet and lean slightly more to one side of the board than the other to steer the board in the desired direction.

Most skateboards are made with a deck, such as a board 28 to 33 inches long, made of wood, fiberglass, bamboo, resin, Kevlar, carbon fiber, aluminum, plastic or any other material with sufficient strength and rigidity to support both the hardware and the boarder. FIG. 1 from the prior art illustrates one such typical skateboard.

Decks are of variable sizes. For example, most are 7 to 10 inches in width or even wider for greater stability. They are designed for a boarder to use one foot at an angle on the board and be able to press with the heel to steer the board in a first direction, and alternatively, to press down with the toes to steer the board in the opposite direction.

Decks can be painted or customized with artwork, and the underside of the deck can include a shock resistant or abrasion-resistant laminated material. Many of the tricks performed with a skateboard result in strong impacts and friction to the board in the area between two pairs of wheels for some level of stability. Grip tape or other type of nonslip surface treatment can be applied to the top of the board to help boarders perform different tricks. For example, if the board is bounced off the ground onto a stainless steel hand rail, the board slide downwards. The grip tape on the top of the deck provides stability for the boarder while the bottom side of the deck, often painted, allows the boarder to slide on rails or other surfaces and fixtures.

While skateboards may appear to be simple devices, their competitive use is extremely complex and calls into play advanced notions of dynamics, impact resistance, static and dynamic friction, rotational inertia, and the like. The desire of skateboarders to customize every aspect of their skateboards is well known. Much like musical instruments, each board is somewhat unique and reacts differently to different solicitations. Over the decades, the practice of this sport has been influenced, much like surfing and motorcycling, by a strong instinct of freedom, independence, and individualism. For this reason, any aesthetic change, much like any functional change, is also highly desirable.

As shown on FIG. 1, two sets of wheels are attached to the underside of the deck using a truck. Trucks are generally made of an aluminum alloy and include a grommet to provide the axis of the wheels with some degree of flexibility of movement. Most trucks and their grommets allow for a movement of the deck over the ground on which the skateboard can rotate left or right by as much as 38 to 50 degrees. Wheels are attached to an axle that runs through a hanger located inside the truck.

Wheels of a skateboard are generally fixed to the axle using standardized wheels with ball bearings located inside the wheel and locked in place with a nut. Since one of the most vulnerable portions of the skateboard is the wheel and the bearing set, a boarder typically knows how to service and replace wheels and bearings. Skateboard wheels are generally made of a hard polyurethane and come in many sizes and shapes, though they are generally cylindrical as illustrated at FIGS. 1 and 2. FIG. 2 shows how two bearing sets can be placed on each side of a central portion to hold the wheel in place.

Larger wheels can have an external diameter of 54 to 85 mm in size. They roll faster and can more easily roll over cracks in pavements than smaller wheels. Smaller wheels of 48 to 54 mm in size are designed to keep the board closer to the ground and require less force to accelerate. Lower boards have a different center of gravity and thus handle differently.

Normal wheels range from a hardness of Shore A 75 (very soft) to about A 101 (very hard). As the A scale stops at 100, any wheels labeled 101 A or higher are harder but use a different durometer scale. Some wheels are sold using a B or D hardness scale as those scales have a larger and more accurate range of hardness. Finally, bearings over the years have been standardized to a fixed size, namely, an outer diameter of 22 mm, a width of 7 mm, and a bore of 8 mm, which together is called the 608 standard industrial size. The bearings are generally made of steel, though silicon nitride and high-tech ceramic, can be used. As for the hardness of the wheels, the ABEC scale is used. These values range from ABEC1 to ABEC9. In most models of skateboards, the bolt is a 10-32 UNC bolt, usually an Allen or Phillips head, and has a matching nylon locknut. FIGS. 1 and 2 show a typical skateboard from the prior art with cylindrical wheels.

Other types of wheels have been developed over the years with different shapes. For example, the prior art of FIGS. 3 and 4 show the wheel is round and ball shaped. The balls are attached through their center axis and require a different style of attachment. What is required is a simplified system for using a ball-shaped wheel on a skateboard that does not require specific adaptation and results in completely novel maneuvering dynamics for the skateboarder.

What is further required is a skateboard wheel providing the advantages of a curved outer surface but may not have the outer surface of a true sphere. A wheel is also required that provides the structure to enable a skateboard rider to perform substantially all of the stunts and tricks that can be performed on a traditional wheel while providing the improvements as previously discussed.

### SUMMARY

The present disclosure generally relates to a spherical or curved skateboard wheel that is interchangeable with ordinary, standardized skateboard wheels used in the marketplace. The wheel in some embodiments provides greater weight to the board and protects the internal bearings by avoiding preferential shock positions within each wheel. Further, the spherical wheels allow for a higher rate of speed, reduced friction when steering the board, reduction of random bounces of the board during tricks, and increased maneuverability over dry, granular, or soft surfaces.

The curved skateboard wheel may also include a grind face that enables the rider to more easily perform tricks and stunts that otherwise would be more difficult if the entire outer surface of the wheel is curved.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is a perspective illustration of a skateboard from the prior art.

FIG. 2 is cut view of a skateboard axle and wheel according to an embodiment from the prior art.

FIG. 3 is a side view of a skateboard from the prior art equipped with spherical wheels with external connections according to an embodiment from the prior art.

FIG. 4 is a rear view of the skateboard of FIG. 3 from the prior art.

FIG. 5 is a perspective view of a new spherical skateboard wheel according to an embodiment of the present disclosure.

FIG. 6A is a side view of the wheel of FIG. 5.

FIG. 6B is a plan view of the wheel of FIG. 5 taken along cut line 6B-6B as illustrated on FIG. 6A.

FIG. 7 is a perspective illustration of a skateboard equipped with four wheels as illustrated in FIG. 5 according to an embodiment of the present disclosure.

FIG. 8 is a diagram illustrating the comparative contact traces of a skateboard with cylindrical wheels from the prior art and the skateboard with spherical wheels shown at FIG. 7.

FIG. 9 is a diagram illustrating the movement of wheels on a skateboard as a user pushes on a portion of the deck to steer the board.

FIG. 10 illustrates the relative trace movement over the ground associated with steering a skateboard from the prior art.

FIG. 11 illustrates the relative trace movement over the ground associated with steering the skateboard as shown at FIG. 7.

FIG. 12 is a momentum diagram of the different forces on the wheels of a skateboard from the prior art.

FIG. 13 is a momentum diagram of the different forces on the wheels of a skateboard as shown at FIG. 7.

FIG. 14 is a diagram illustrating the steps of a method for upgrading a skateboard.

FIG. 15 is a perspective view of a new ellipsoidal skateboard wheel with grind face according to an embodiment of the present disclosure.

FIG. 16A is a side view of the wheel of FIG. 15

FIG. 16B is a plan view of the wheel of FIG. 15 taken along cut line 16B-16B as illustrated on FIG. 16A

FIG. 17 is a diagram illustrating an ellipsoid.

FIG. 18 is a diagram illustrating the steps of a method for upgrading a skateboard.

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

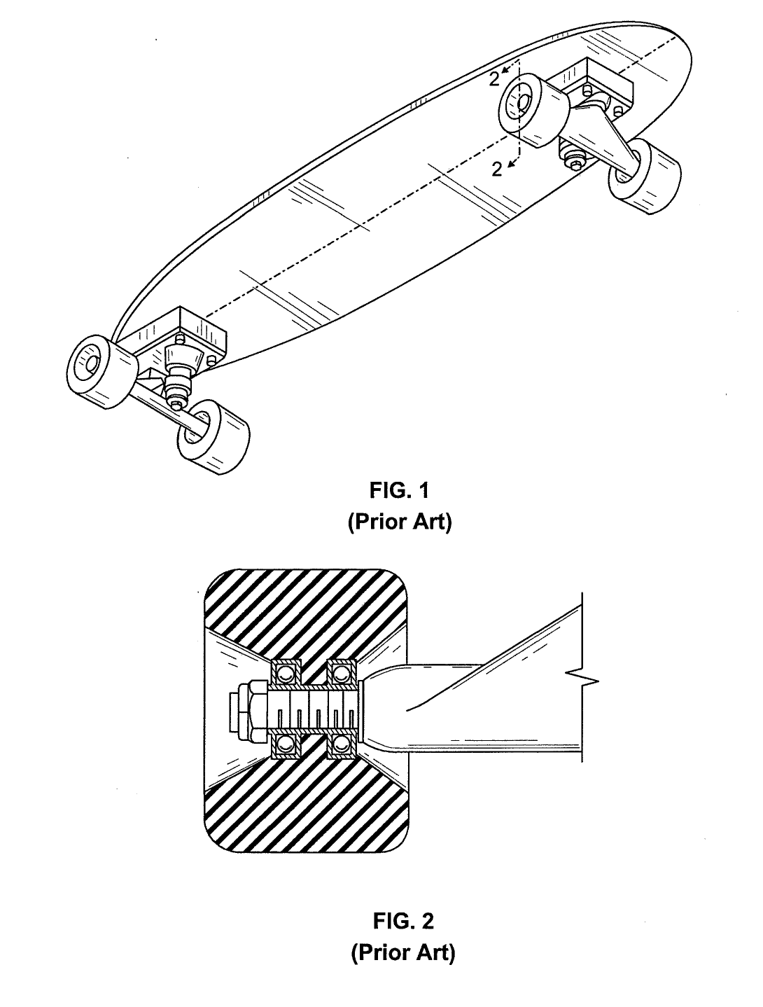

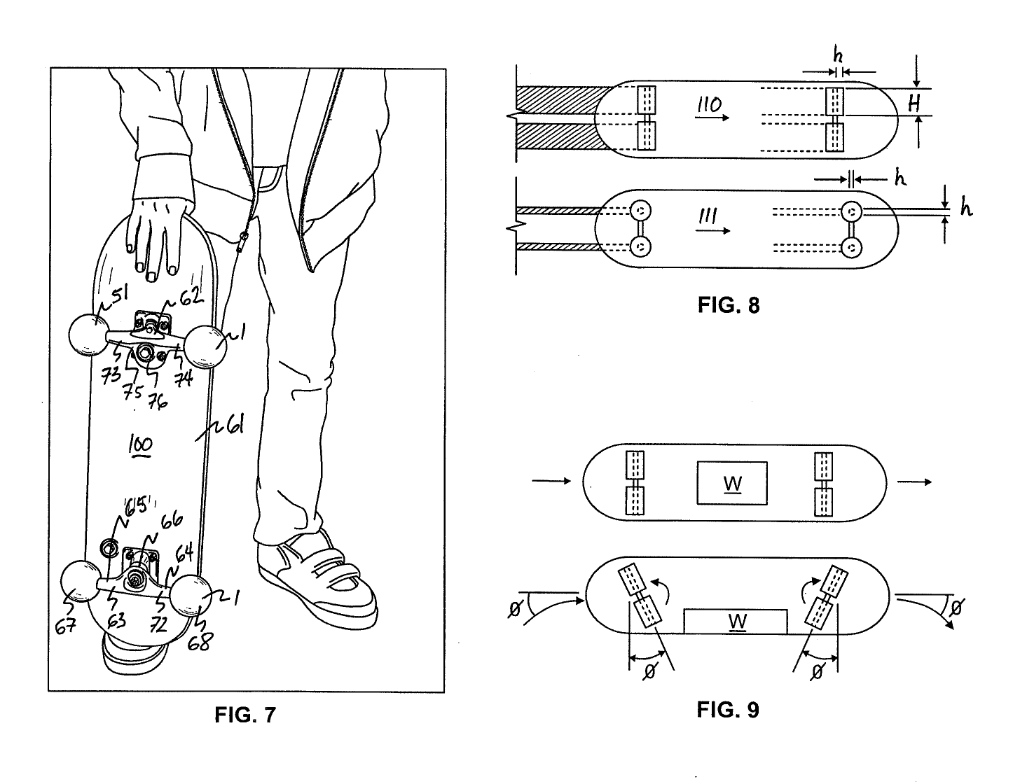

The current disclosure relates to a new type of wheel 1 for a skateboard 100 having several unique properties alone or when used in combination with a board already equipped with ordinary wheels as shown at FIG. 1. To illustrate the differences associated with mounting wheel 1 as illustrated on FIG. 5 on a skateboard 100 as shown in FIG. 7, an understanding of some skateboard dynamics are needed.

A spherical wheel 1 as shown in FIG. 5 is compact and is also one of the most structurally sound shape. Rounded balls are difficult to damage and chip. As a consequence, to withstand the same level of strain and shear forces as conventional skateboard wheels, spherical wheel 1 can be made with material having lower resistance to impact and wear. Further, spherical wheels 1 has a greater capacity to bounce under impact as a greater level of energy placed on the body transits through its center of gravity as the normal perpendicular direction at any area on the surface of a rounded body is the center of the rounded body.

Skateboards as known in the art have cylindrical wheels as shown in FIG. 2, or smaller wheels of somewhat different shape. For example, in-line skates have narrow, cylindrical wheels with curved edge surfaces. The cylindrical wheels shown in FIG. 8 have an width (H) and contact the ground over a wide track as shown in FIG. 8. Obvious advantages of the use of this style of wheels is the inherent stability of the skateboard, as a great effort is needed to flip the skateboard. Further, the wheels are not exceptionally fast as they have high surface contact with the ground and face high frictional resistance. As a consequence, the maximum speed of a board is limited by the size and diameter of the wheels. A slower wheel profile may be preferable for children.

Outdoor surfaces have asperities such as cracks in sidewalk cement, a rugged surface finish on asphalt streets, and obstacles such as rocks, pebbles, and metal drains openings. As more surface areas is traversed by wide wheels, a higher number of asperities must be rolled over. This is shown in FIG. 8 where the trace left by rounded wheels (h) is compared with the larger trace of larger cylindrical wheels (H).

On both a microscopic and macroscopic level, ground asperities result in a dynamic friction (μ_{d}) that in turn results in a frictional force (F_{d}=μ_{d}*S) that opposes the movement of the board. In this equation, S is the contact surface area such as S=(∂v/∂t)*H and where v is the velocity of the board on flat ground. Movement of the board is generated by a push and ultimately a downward component of the weight of the skateboarder if the board is on a negative incline. Forces that oppose movement include friction inside each wheel and the dynamic friction force F_{d}. FIG. 8 illustrates how a wheel with a narrower trace, such as a spherical wheel, contacts the ground over a smaller width (h) and therefore encounters a lower frictional force at the same speed.

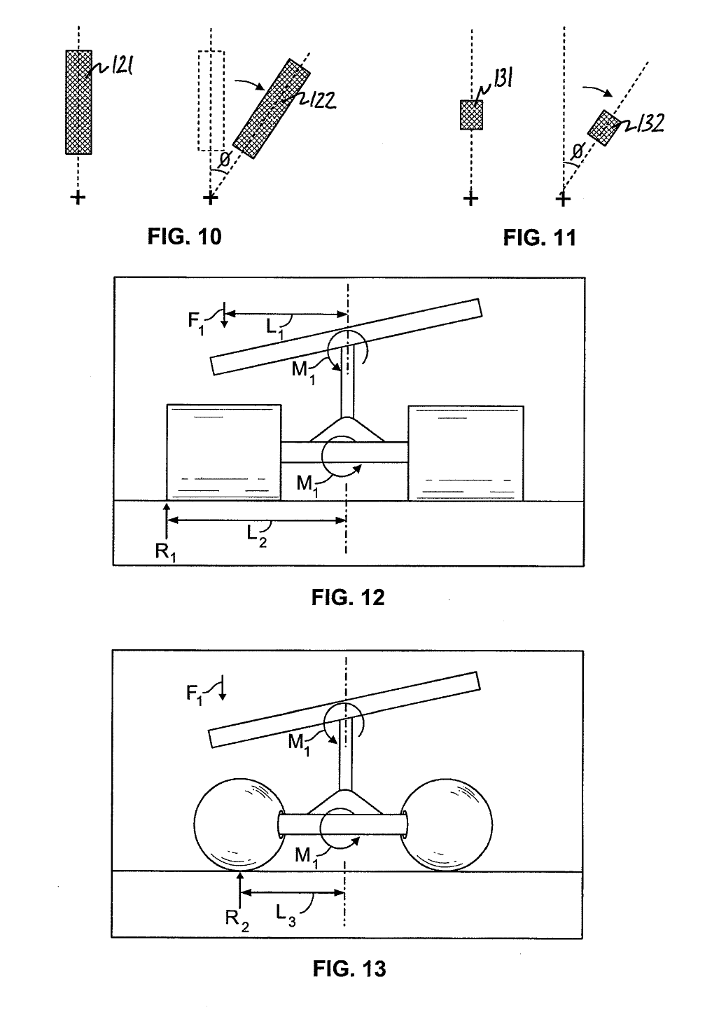

The wheels 1 do not always travel in a single direction. A skateboarder often directs the skateboard by placing the weight (W) as shown at FIG. 9 downwards on a portion of the board to create different effects. When the weight is placed on an external area the two sets of wheels rotate inwards by an angle θ and thus the board also steers or rotates with the same approximate angle. The rotation of the wheels on the pavement is illustrated by two small arrows 110, 111. FIGS. 10 and 11 show how the contact area below a single wheel is instantly slid over the ground from a first position 121, 131 to a second position 122, 132. As a result of this translation and rotation, additional dynamic and static frictional forces are created on the board resulting from the torsion of the surface below the wheel in addition to the width (H v. h). The greater the surface area of contact, the greater the force W is needed on the board to steer and initiate the rotation.

For example, if the width is reduced from H to h, where the contact area of a spherical surface is reduced to the smallest required size, the board will require less pressure from the rider to rotate the wheels. Thus, the board will be more reactive and will require less force to move and maneuver. Further, as less energy is used to overcome friction, the maximum speed of the board is increased. Alternatively, it is often the practice of skateboarders to zig-zag down a hill to demonstrate facility and/or to slow down the board, the spherical wheels 1 will also change this behavior.

FIGS. 12 and 13 are momentum diagrams of a skateboard equipped with cylindrical and spherical wheels, respectively. These diagrams show how different momentum forces are created in a board. As a skateboarder pushes downwards on the board F₁ to initiate a wheel rotation, with an assumed fixed width deck, a momentum M₁ is created that is equal to M₁=L₁*F₁. For the purpose of the example, the same force F₁ and the same resulting momentum M₁ is create into both boards shown in FIGS. 12 and 13. The truck transfers the momentum M₁ to the point of contact where a reaction is created on the ground (R₁ or R₂). Based on the distance where the reaction force is produced (L₂ v. L₃) the reaction will differ. Since R₁*L₂=M₁=R₂*L₃, and L₂ and L₃ are fixed values, we find that L₃=L₂−½W, resulting in the following equation:

$$\frac{{R}_{1}}{{R}_{2}} = \frac{{L}_{3}}{{L}_{2}} = \frac{{L}_{2} - \frac{W}{2}}{{L}_{2}} = \frac{W}{2 * {L}_{2}}$$

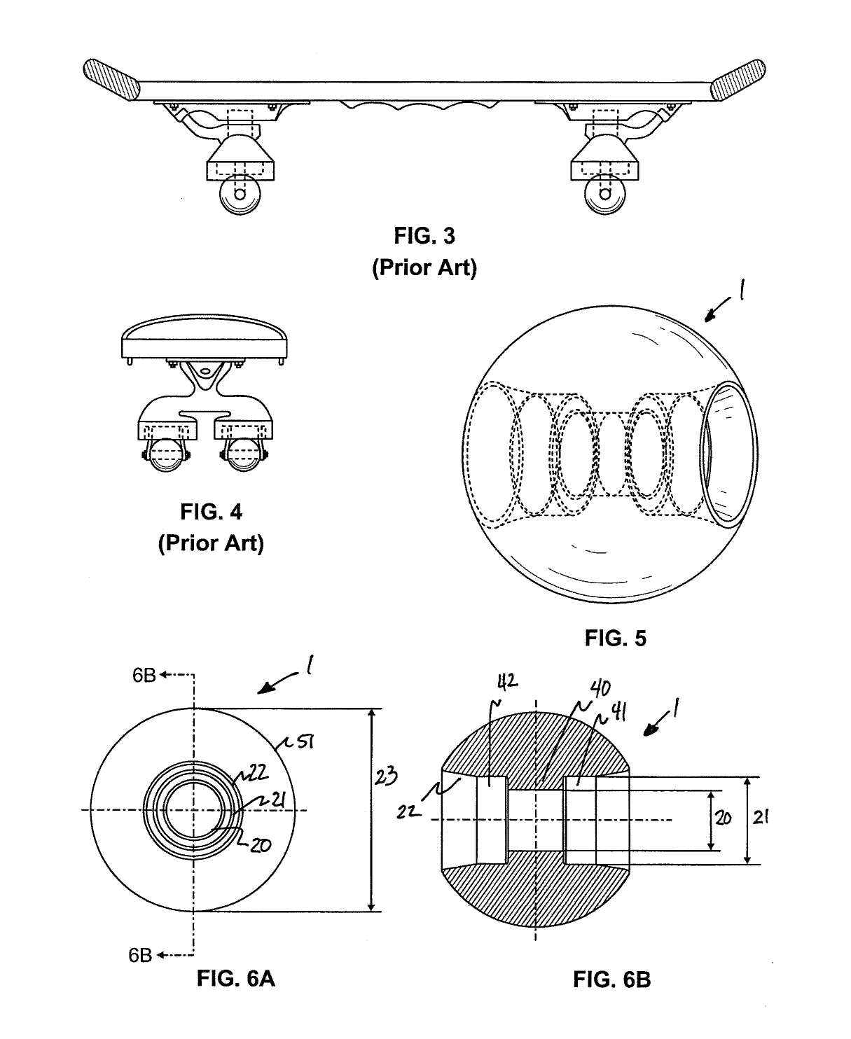

At the same point of attachment, unlike the devices from the prior art shown in FIGS. 3 and 4, the reaction force R₂ is always greater than the reaction R₁, and as shown in FIG. 7, the point of reaction R₂ can be calibrated to fall closer to the internal axis of the board to improve the dynamics of the board. For a spherical wheel 1, unlike other wheels types, the reaction R₂ is always perpendicular to the surface of the body and therefore is directed to the center of the wheel 1, in this case the point of attachment on the axle. The force is accordingly centered between the bearing sets located inside the wheel 1 to help protect the wheel material.

In the illustration shown at FIG. 12, the force R₁ is perpendicular to the external edge of the wheel until the wheels on the other side lift from the ground. R₁ may result in greater local chipping of the wheel 1 creating strain concentrations and shear forces in the bearing often offset from the force. In the spherical wheel 1, no shear force or strain concentration is created in the bearing sets located in bearing grooves 41, 42 each side of the locking lip 40. In the prior art shown in FIGS. 3 and 4, the force R₂ is not located at the connection point or inside of bearing set.

Further advantages of a spherical wheel 1 include an easier surface to clean, a stronger wheel structure because spheres are inherently stronger than cylinders, and a wheel capable of offering its full support even if the board is lifted on its side and is being manipulated partly off the ground. In conventional wheels or even in the wheel system shown in FIGS. 3 and 4, the ground simply cannot be ridden with the board at 45 degrees as the reaction force from the ground is unstable as it is on an edge of the wheel.

In one contemplated embodiment, the central opening 20 is 14 mm long and has an internal radius of 15 mm. Lateral bearing openings 21 for the bearing sets are also 7 mm thick and have an external diameter of 22 mm. A small, conical opening 22 is made to guide insertion of the bearing where the external opening is a maximum of 25.4 mm. In one embodiment, the sphere has an outer diameter 23 of 54 mm.

The material used in one embodiment is polyurethane without regrind having a durometer value of 87 A, 95 A, 99 A or 100 A. The external finish on the external surfaces is SP1 grade 1 and in the internal surfaces SP1 grade 2. One other known advantages of using a spherical wheel 1 in conjunction with a skateboard having a deck with two trucks, each with grommets and axles having principal axis perpendicular to the body of the deck, is that any asperity or irregularity of the external surface of the wheel, such as, for example, molding asperities, will be shaved or worn off as the wheel 1 is used. In another embodiment, the regularly shaped external wheel surface allows for the creation of an external contact area either as part of the wheel 1 or attached to the external surface of the wheel having a curved ring shape.

Further, the use of a spherical wheel 1 allows the board to move over an area with particles, dirt, gravel, or other material and displace laterally the material much like a ship advances through water, allowing for better penetration of the board over these mediums.

Different methods of manufacturing the wheel 1 are contemplated. The wheel 1 can be injected into a mold having the internal configuration as shown in FIG. 6B. Creation of the wheel 1 machined from a sphere is also contemplated. In any order, a cylindrical perforation 20 of the minimum diameter can be made from one side of the rounded sphere to the opposing side. The perforation resulting in areas where the sphere can be placed flat on a surface during machining steps. A second larger perforation can be made either at a light angle 22 or directly at the external diameter 21 of bearings on either side of the central perforation 20, and finally, a third perforation is made to complete the structure by either doing the light angle 22 or the seating area 41, 42 for the bearings having a fixed external diameter.

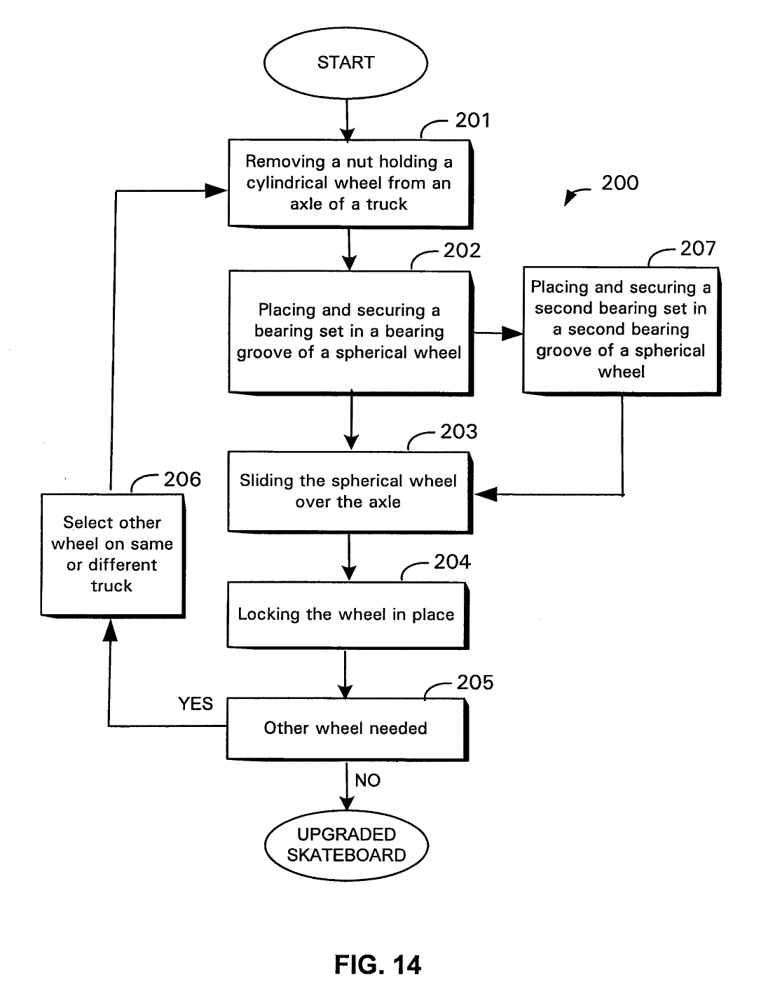

What is described and also shown in FIG. 14 is a method 200 for upgrading a skateboard 100, the method comprising the steps of removing 201 a nut holding at least one cylindrical wheel 1 from an axle of a truck connected to a deck of a skateboard, placing 202 and securing a bearing set in a bearing groove inside of an inner opening 20 of a first wheel with a spherical external surface 51, where the inner opening 20 includes an inner locking lip 40 adjacent to the bearing set inserted in the bearing groove 41 and a guide angle 22 for guiding the bearing set to the bearing groove 41, and sliding 203 the first wheel equipped with the bearing set over the axle. Further steps include locking 204 in place the first wheel using a locking nut mounted on the axle to secure the locking lip 40 and the bearing set to the axle to allow the first wheel to rotate around the axle.

In another embodiment, what is contemplated is the step of placing 207 and securing at least a second bearing set in the bearing groove 42 inside of the inner opening 20 of a second wheel of identical configuration as the first wheel, sliding 203 the second wheel equipped with the bearing set over the axle of the truck, and locking 204 in place the second wheel using a second locking nut mounted on the axle to secure the locking lip and the bearing set of the second wheel to the axle to allow the second wheel to rotate around the axle. The selection step of wheels is shown in FIG. 14 as 206.

What is also contemplated is a method for altering the center of gravity and changing the maneuverability of a skateboard 1, the method comprising the step of replacing a set of at least two cylindrical shaped wheels as shown in FIG. 1 or 2 with spherical wheels as shown in FIG. 7 adapted for mounting on an axle of the at least two cylindrical wheels. The method includes a configuration as shown in FIGS. 12 and 13 where the spherical wheels are of a diameter 23 of approximately the length of the cylindrical wheels W and where the spherical wheels 1 include an outer surface 51 having a spherical shape with a rounded contact area for rolling as shown in FIG. 8 and an inner surface with two bearing grooves 41, 42 adjacent to a central locking lip 40 inside an inner opening 20 and where the two bearing grooves 41, 42 used inside the cylindrical wheels as shown in FIG. 2 are placed inside the two bearing grooves 41, 42 of the spherical wheels 1 as shown in FIG. 5.

Finally, in yet another embodiment, FIG. 7 shows is a skateboard 100 comprising a flat deck 61, at least a truck 62 connected to the flat deck 61 including an axle 63 with opposite ends 64, 65 and a grommet 66 between the opposite ends of the axle 64, 65, and at least two wheels 67, 68, each wheel located at one of the opposite ends of the axle 64, 65, each wheel 67, 68 pivotally connected to roll along an axis of the axle 63 using a bearing set and a nut, and where each of the at least two wheels 67, 68 has a spherical outer surface 51.

FIG. 7 also shows that the skateboard 100 includes two trucks 62, 72, each connected to the flat deck 61, where each truck 62, 72 includes an axle 63, 73 as shown with opposite ends 64, 65, and 74, 75 and a grommet 66, 76 between the opposite ends of each axle.

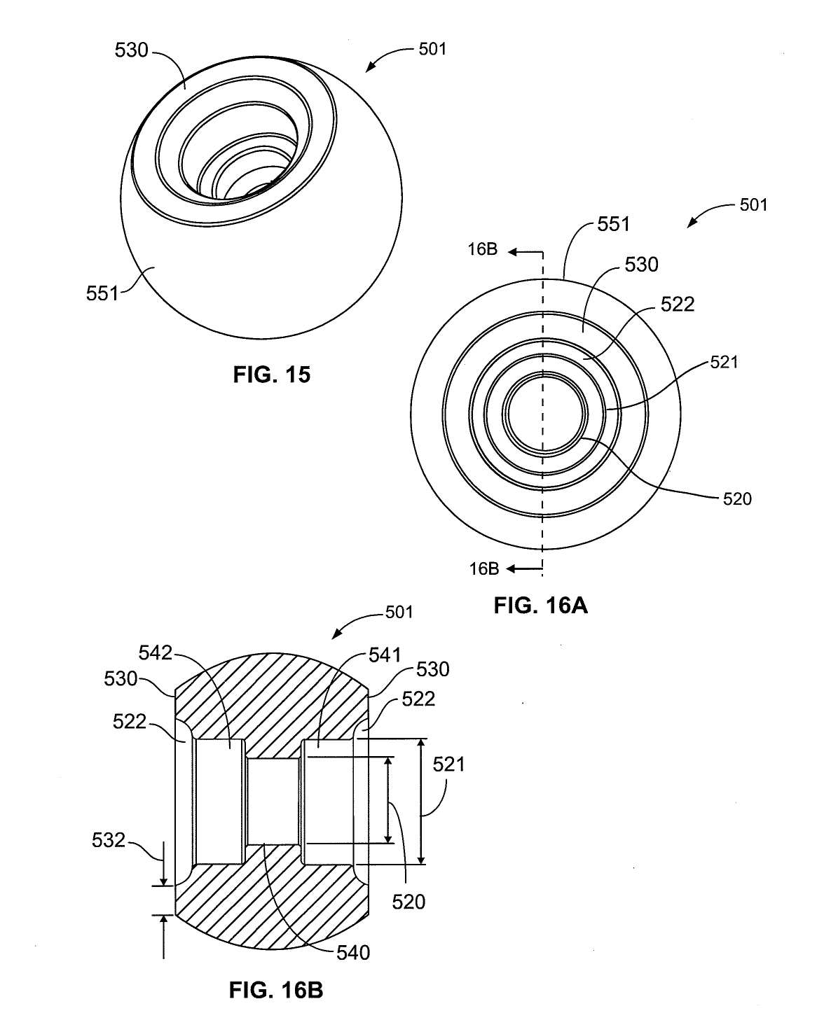

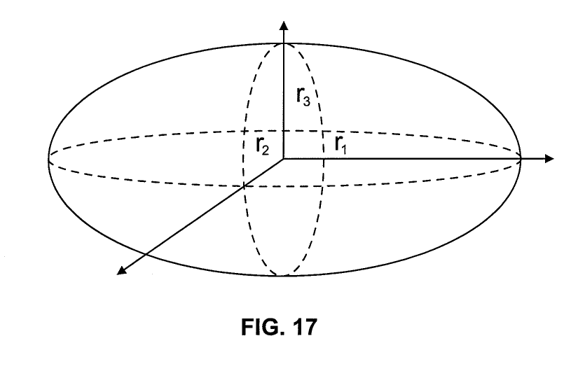

In another embodiment, the spherical wheels 501 also include a grind face as shown in FIG. 15. The grind face 530 is a planar surface generally perpendicular to the center axis of the axle of the truck when the wheel is mounted on a skateboard. The grind face 530 is symmetrical on both sides of wheel 501 on the axis of the mounting holes of wheel 501. The grind face 530 truncates the curved shape of the outer surface of the wheel as previously described and results in a wheel with a width smaller than that of a sphere. In one embodiment the outer surface is truncated such that the overall width of the wheel measures between 34 mm and 37 mm. The grind face 530 gives the wheel a surface that enables the rider to perform stunts and tricks that require such a surface. A grind surface at an angle other than perpendicular to the center axis of the truck could be used. As such, any generally flat surface on the ends of a curved outer surface skateboard wheel that provides the characteristics as described is contemplated.

In a contemplated embodiment with the grind face 530, the wheel 501 has a central opening 520 and is 10 mm long and has an internal diameter of 15 mm. The wheel 501 also has counterbores that serves as lateral bearing openings 521 for the bearing sets. The lateral bearing openings 521 are 9 mm thick and have an external diameter of 22 mm. A shallow, concave opening 522 is made to help guide insertion of the bearing and to help reduce the mass of overall wheel 501. The concave opening is sized such that the ring-shaped planar surface of grind face 530 has a width 532 of approximately 5 mm.

In another contemplated embodiment, the wheel is not spherical but is ellipsoidal in shape. As such, the outer surface of the wheel is rounded but is also elongated in the direction along the axis of the truck of the skateboard. As is known to one of ordinary skill in the art, an ellipsoid is a three-dimensional shape with curved outer surfaces that can be defined by three radii each measured along one of the three axes of a Cartesian coordinate system. The three radii that can define an ellipsoid are shown in FIG. 17 and are labeled r₁, r₂, and r₃. The radii, r₁, r₂, and r₃, can also be described as an axial radius, a width radius, and a height radius, respectively. In the special case in which r₁, r₂, and r₃ are equal, the ellipsoid is a sphere. In the case where r₁ is larger than, r₂, and r₃, an elongated curved surface is defined.

In one contemplated embodiment, r₁, r₂, and r₃ are equal and the outer surface of wheel 501 is a that of a sphere. The radii that define the outer surface of the wheel of this embodiment measure in the range of 26 mm to 30 mm, however, other radii can be used that provide the characteristics of this disclosure. In another embodiment, r₂ is equal to r₃ but r₁ is larger. In this type of embodiment, for example, r₁ and r₂ can both measure 30 mm but r₁ measures 60 mm. In this type of embodiment, a cross-section of the wheel is a circle in a plane perpendicular to the center axis of the mounting axle of the truck and the cross-section is elliptical in a direction along the center axis truck axle. While the term ellipsoid is used in this disclosure, any curved surface with the characteristics described herein or with an outer curved rolling surface is contemplated.

In an embodiment with an ellipsoidal wheel, the wheel may also contain a grind face as previously described. The grind face truncates the ellipsoidal outer surface and results in a generally flat surface providing the characteristics as preciously described.

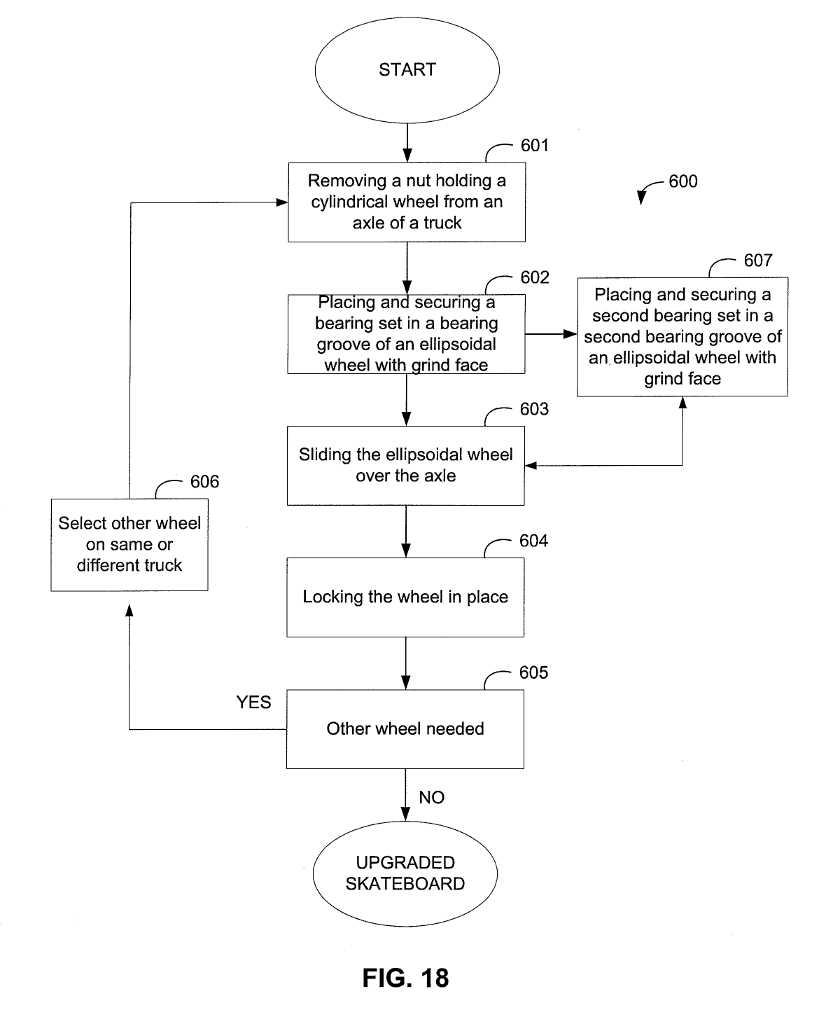

What is described and also shown in FIG. 18 is a method 600 for upgrading a skateboard 100, the method comprising the steps of removing 601 a nut holding at least one cylindrical wheel 501 from an axle of a truck connected to a deck of a skateboard, placing 602 and securing a bearing set in a bearing groove inside of an inner opening 520 of a first wheel with an ellipsoidal external surface 551, where the inner opening 520 includes an inner locking lip 540 adjacent to the bearing set inserted in the bearing groove 541 and a concave surface 522 for guiding the bearing set to the bearing groove 541, and sliding 603 the first wheel equipped with the bearing set over the axle. Further steps include locking 604 in place the first wheel using a locking nut mounted on the axle to secure the locking lip 540 and the bearing set to the axle to allow the first wheel to rotate around the axle.

In another embodiment, what is contemplated is the step of placing 607 and securing at least a second bearing set in the bearing groove 542 inside of the inner opening 520 of a second wheel of identical configuration as the first wheel, sliding 603 the second wheel equipped with the bearing set over the axle of the truck, and locking 604 in place the second wheel using a second locking nut mounted on the axle to secure the locking lip and the bearing set of the second wheel to the axle to allow the second wheel to rotate around the axle. The selection step of wheels is shown in FIG. 18 as 606.

What is also contemplated is a method for altering the center of gravity and changing the maneuverability of a skateboard, the method comprising the step of replacing a set of at least two cylindrical shaped wheels as shown in FIG. 1 or 2 with ellipsoidal wheels with a grind face 530 as shown in FIG. 15 adapted for mounting on an axle of the at least two cylindrical wheels. The method includes a configuration where the ellipsoidal wheels with grind face include an outer surface 551 having an ellipsoidal shape with a rounded contact area for rolling and an inner surface with two bearing grooves 541, 542 adjacent to a central locking lip 540 inside an inner opening 520 and where the two bearings used inside the cylindrical wheels as shown in FIG. 2 are placed inside the two bearing grooves 541, 542 of the ellipsoidal wheels 501 as shown in FIG. 15.

It is understood that the preceding detailed description of some examples and embodiments of the present invention may allow numerous changes to the disclosed embodiments in accordance with the disclosure made herein without departing from the spirit or scope of the invention. As one of ordinary skill in the art understands, references have been made to specific figures and characteristics of the invention, however, the teachings of the disclosure are transferable between the various examples and embodiments described and have not been made to limit the scope of the invention. The preceding description, therefore, is not meant to limit the scope of the invention but to provide sufficient disclosure to one of ordinary skill in the art to practice the invention without undue burden.

What is claimed is:

1. A method for upgrading a skateboard, the method comprising the steps of:
removing a nut holding at least one cylindrical wheel from an axle of a truck connected to a deck of a skateboard;
placing and securing a bearing set in a bearing groove inside of an inner opening of a first wheel with an ellipsoidal external surface and a grind face, wherein the inner opening further includes an inner locking lip adjacent to the bearing set inserted in the bearing groove;
sliding the first wheel equipped with the bearing set over the axle;
locking in place the first wheel using a locking nut mounted on the axle to secure the locking lip and the bearing set to the axle to allow the first wheel to rotate around the axle;
placing and securing at least a second bearing set in the bearing groove inside the inner opening of a second wheel of identical configuration as the first wheel;
sliding the second wheel equipped with the bearing set over the axle of the truck; and
locking in place the second wheel using a second locking nut mounted on the axle to secure the locking lip and the bearing set of the second wheel to the axle for allowing the second wheel to rotate around the axle.

2. The method of claim 1, wherein the bearing set is a ball bearing with an external diameter of 22 mm.

3. The method of claim 2, wherein each of the first and second wheels includes two bearing grooves on each side of the locking lip and wherein each step of placing and securing the bearing set into the bearing groove includes the additional step of placing a second bearing set into the other bearing groove.

4. The method of claim 3, wherein the ellipsoidal wheels are made of a material having a hardness between 87 A and 100 A.

5. The method of claim 4, wherein the hardness is selected from a group consisting of 87 A, 95 A, 99 A, and 100 A.

6. The method of claim 1, wherein the grind face is ring-shaped and disposed generally perpendicular to a center axis of the axle of the truck when the wheel is secured to skateboard.

7. A method for altering the center of gravity and changing the maneuverability of a skateboard, the method comprising the step of replacing a set of at least two cylindrical wheels with ellipsoidal shaped wheels with a grind face adapted for mounting on an axle of the at least two cylindrical wheels, wherein the ellipsoidal wheels with a grind face are of a diameter of approximately the length of the cylindrical wheels, wherein the ellipsoidal wheels include an outer surface having a rounded shape with a rounded contact area for rolling and an inner surface with two bearing grooves adjacent to a central locking lip inside of an inner opening, and wherein the two bearings used inside the cylindrical wheels are placed inside the two bearing grooves of the ellipsoidal wheels.

8. The method of claim 7, wherein the ball bearings are cylindrical and have an internal diameter of 8 mm and an external diameter of 22 mm.

9. The method of claim 8, wherein the ellipsoidal wheels are made of a material having a hardness between 87 A and 100 A.

10. The method of claim 9, wherein the hardness is selected from a group consisting of 87 A, 95 A, 99 A, and 100 A.

11. A skateboard comprising:
a flat deck;
at least a truck connected to the flat deck including an axle with opposite ends and a grommet between the opposite ends of the axle; and
at least two wheels, each wheel located at one of the opposite ends of the axle, each wheel pivotally connected to roll along an axis of the axle using a bearing set and a nut, wherein each of the at least two wheels has an ellipsoidal outer surface with a grind face.

12. The skateboard of claim 12, wherein the skateboard includes two trucks, each connected to the flat deck, and wherein each truck includes an axle with opposite ends and a grommet between the opposite ends of each axle.

13. The skateboard of claim 13, wherein the ellipsoidal outer wheel surface has an outside diameter of approximately 54 mm.

14. The skateboard of claim 12, wherein each wheel is made of a polyurethane having a hardness selected from a group consisting of 87 A, 95 A, 99 A, and 100 A.

15. The skateboard of claim 15, wherein the ellipsoidal wheels are made of a material having a hardness between 87 A and 101 A.

16. The skateboard of claim 15, wherein each of the at least two wheels include an inner surface with two bearing grooves adjacent to a central locking lip inside of an inner opening.

17. The skateboard of claim 12 wherein the grind face is a ring-shaped planar surface generally perpendicular to a center axis of the axle.

18. The skateboard of claim 18 wherein the grind face has an approximate width of 5 mm.

19. The skateboard of claim 12 wherein the ellipsoidal outer surface is defined by a height radius measured from a center of the wheel to an upper surface of the wheel, a width radius measured from the center of the wheel to a front surface of the wheel, and an axial radius measured from the center of the wheel to a figurative axial surface of the wheel, the height radius being equal to both the width radius and the axial radius.

20. The skateboard of claim 12 wherein the ellipsoidal outer surface is defined by a height radius measured from a center of the wheel to an upper surface of the wheel, a width radius measured from the center of the wheel to a front surface of the wheel, and an axial radius measured from the center of the wheel to a figurative axial surface of the wheel, the height radius being equal to the width radius and the axial radius being different.
